(19) United States
(12) Patent Application Publication
(10) Pub. No.: US 2025/0314509 A1
(43) Pub. Date: Oct. 9, 2025

(54) SYSTEM AND METHOD FOR SENSING ONE OR MORE FLUID FLOW PARAMETERS OF A FLUID WITHIN A PIPE

(71) Applicant: Weatherford Technology Holdings, LLC., Houston, TX (US)

(72) Inventor: Domino TAVERNER, Houston, TX (US)

(73) Assignee: Weatherford Technology Holdings, LLC., Houston, TX (US)

(21) Appl. No.: 18/627,918

(22) Filed: Apr. 5, 2024

Related U.S. Application Data
(60) Provisional application No. 63/574,362, filed on Apr. 4, 2024.

(51) Int. Cl. G01F 1/661; F17D 3/18; G01F 1/74

(52) U.S. Cl. CPC G01F 1/661; F17D 3/18; G01F 1/74

(57) ABSTRACT

Examples are disclosed herein for sensing one or more fluid parameters of a flowing fluid. A flowmeter can include high and low sensitivity coils. The low sensitivity coils can include optical coils for sensing one or more fluid flow parameters of flowing fluid. The high sensitivity coils can include optical coils for sensing the one or more fluid flow parameters of the flowing fluid. The low sensitivity coils can be selected so that an instrument receives data from the low sensitivity coils indicative of the one or more fluid flow parameters over a first period of time. The high sensitivity coils can be selected so that the instrument receives data from the high sensitivity coils indicative of the one or more fluid flow parameters over a second period of time.

### RELATED APPLICATION

This application claims the benefit and priority of U.S. Provisional Patent Application Patent No. 63/574,362, filed Apr. 4, 2024, titled “SYSTEM AND METHOD FOR SENSING ONE OR MORE FLUID FLOW PARAMETERS OF A FLUID WITHIN A PIPE,” the entire contents of which is incorporated herein by reference in its entirety.

### FIELD OF THE DISCLOSURE

This disclosure relates to sensing one or more fluid flow parameters within a tubing, such as tubing that is used in the oil and/or gas industry.

### BACKGROUND OF THE DISCLOSURE

In the oil and gas industry, there is considerable value in the ability to monitor the flow of petroleum products in the production pipe of a well in real time. Fluid flow parameters, such as the bulk velocity of a fluid, have traditionally been sensed with venturi type devices directly disposed within the fluid flow. Venturi type devices, however, can provide an undesirable flow impediment, are subject to hostile environments within the pipe, and typically provide undesirable potential leak paths into or out of the pipe. In addition, these devices are only able to provide information relating to the bulk fluid flow and are therefore unable to provide information specific to constituents within a multi-phase fluid flow.

Alternative flow measurement techniques use the speed of sound to determine various parameters of the fluid flow within a pipe. One technique measures the amount of time it takes for sound signals to travel back and forth between ultrasonic acoustic transmitters/receivers (transceivers), sometimes referred to as a “sing-around” or “transit time” method. A disadvantage of this type of technique is that gas bubbles and/or particulates in the fluid can interfere with the signals traveling back and forth between the transceivers. Another disadvantage of this type of technique is that it considers only the fluid disposed between transceivers during the signal transit time. Fluid within a well or oil and gas pipeline is typically not homogenous as the fluid often contains localized concentration variations of water or oil, referred to as “slugs”. Localized concentration variations can affect the accuracy of the data collected.

Multiphase flowmeters can also be used to measure the ratio of individual constituents within a fluid (e.g., a mixture of oil, gas, and water) without requiring separation of the constituents. Most of the multiphase flowmeters that are currently available, however, are designed for use at the wellhead or platform. A problem with utilizing a flowmeter at the wellhead of a multiple source well is that the fluid reaching the flowmeter is a mixture of the fluids from the various sources, which are disposed at different positions within the well. Consequently, although the multiphase flowmeter provides the advantage of providing information specific to individual constituents within a fluid (which is an improvement over bulk flow sensors), the information they provide is still limited because there is no way to distinguish from the various sources.

Acquiring reliable, accurate fluid flow data downhole at a particular source environment is a technical challenge for at least the following reasons. First, fluid flow within a production pipe is hostile to sensors in direct contact with the fluid flow. Fluids within the production pipe can erode, corrode, wear, and otherwise compromise sensors disposed in direct contact with the fluid flow. In addition, the hole or port through which the sensor makes direct contact, or through which a cable is run, is a potential leak site. There is an advantage in preventing fluid leakage out of the production pipe. Second, the environment within most wells is harsh, characterized by extreme temperatures, pressures, and debris. Extreme temperatures can disable and limit the life of electronic components. Sensors disposed outside of the production pipe may also be subject to environmental materials such as water (fresh or salt), steam, mud, sand, etc. Third, the well environment makes it difficult and expensive to access most sensors once they have been installed and positioned downhole.

What is needed, therefore, is a reliable, accurate, and compact apparatus for sensing fluid flow within a pipe in a non-intrusive manner that is operable in an environment characterized by extreme temperatures, pressures and the presence of debris.

### SUMMARY OF THE DISCLOSURE

Various details of the present disclosure are hereinafter summarized to provide a basic understanding. This summary is not an extensive overview of the disclosure and is neither intended to identify certain elements of the disclosure nor to delineate the scope thereof. Rather, the primary purpose of this summary is to present some concepts of the disclosure in a simplified form prior to the more detailed description that is presented hereinafter.

In an embodiment, a sensing system can include a flowmeter. The flowmeter can include low sensitivity coils that can include optical coils for sensing one or more fluid flow parameters of a flowing fluid, and high sensitivity coils that can include optical coils for sensing the one or more fluid flow parameters of the flowing fluid. The low sensitivity coils can be selected and so that an instrument receives data from the low sensitivity coils indicative of the one or more fluid flow parameters over a first period of time. The high sensitivity coils can be selected so that the instrument receives data from the high sensitivity coils indicative of the one or more fluid flow parameters over a second period of time.

In another embodiment, a method can include determining a differential phase change for a flowmeter that can include low and high sensitivity coils that can be used for sensing flow parameters of a fluid within a tubing, and processing data from one of the low and high sensitivity coils in response to the determined differential phase change.

In yet another embodiment, an instrument can include a processor, and memory that can include machine-readable instructions. The machine-readable instructions can be executable by the processor and causing the processor to receive data from low and high sensitivity coils, compare a rate of a differential phase change to a threshold corresponding to a maximum dynamic range of the instrument, process the data from the high sensitivity coils over a first period of time based on the comparison indicating that the rate of the differential phase change is less than the threshold, and process the data from the low sensitivity coils over a second period of time based on the comparison indicating that the rate of the differential phase change is greater than or equal to the threshold.

Any combinations of the various embodiments and implementations disclosed herein can be used in a further embodiment, consistent with the disclosure. These and other aspects and features can be appreciated from the following description of certain embodiments presented herein in accordance with the disclosure and the accompanying drawings and claims.

### BRIEF DESCRIPTION OF THE DRAWINGS

FIG. 1 is a schematic diagram of an example of a sensing system 100.

FIG. 2 is a schematic diagram of an example well system.

FIG. 3 is an example of a flowmeter.

FIG. 4 is another example of a flowmeter.

FIG. 5 is an example of a method for computing one or more fluid parameters of a fluid flowing in a tube.

FIG. 6 is an example of a phase wrapping diagram.

### DETAILED DESCRIPTION

Embodiments of the present disclosure will now be described in detail with reference to the accompanying Figures. Like elements in the various figures may be denoted by like reference numerals for consistency. Further, in the following detailed description of embodiments of the present disclosure, numerous specific details are set forth in order to provide a more thorough understanding of the claimed subject matter. However, it will be apparent to one of ordinary skill in the art that the embodiments disclosed herein may be practiced without these specific details. In other instances, well-known features have not been described in detail to avoid unnecessarily complicating the description. Additionally, it will be apparent to one of ordinary skill in the art that the scale of the elements presented in the accompanying Figures may vary without departing from the scope of the present disclosure.

Optical flowmeters can be used for non-invasively (or non-intrusively) measuring flow parameters within a tubing inside a well. U.S. Pat. No. 6,782,150 (hereinafter, “the '150 Patent”) describes such an optical flowmeter. The optical flowmeter can include an optical fiber that is wrapped around production piping (the tubing) and is used to measure the flow parameters within the pipe using interferometric techniques, and thus interferometric-based instruments. Such flow parameters can include a speed of sound in a fluid in the tubing and a bulk velocity of turbulent fluids in the tubing. The speed of sound in the fluid refers to a rate at which sound waves travel through the fluid. The speed of sound can be measured in meters per second (m/s). The speed of sound depends on properties of the fluid (e.g., a density and elasticity, for example). In a given medium, sound waves can travel at a constant speed, which can be altered by changes in a medium's properties. Bulk velocity refers to an average velocity of a fluid flowing through a pipe. It measures how fast the fluid is moving in general (e.g., without regarding the variations in velocity that might occur at different points in a cross section of the pipe). Because bulk velocity is a velocity measurement, it can be measured in m/s, similar to a speed of sound measurement.

The fiber of the optical flowmeter can be wrapped around the flowmeter tubing at a location to produce a sensor coil. The sensor coil can consist of multiple layers of fiber wrapped over a short length of tubing (e.g., over about 1 inch of tubing length). A length of fiber in a sensor coil can be in a range of 10 meters (m) to 100 m in some instances. There can be multiple sensor coils on the flowmeter fiber at locations spaced along the flowmeter tubing. In some examples, there can be a fiber Bragg grating disposed in the fiber before and after each sensor coil to form an interferometric optical cavity around each sensor coil that can be utilized by an interrogating instrument.

The optical flowmeter can include a first optical fiber and a second optical fiber with each fiber containing a set of sensor coils at a spacing along the tubing suitable for producing signals to determine the speed of sound in the fluid and a set of sensor coils at a spacing suitable for producing signals to determine the bulk velocity of the fluid. In some examples, the two sets of sensor coils in a given fiber can share one or more sensor coils. In some examples, a same set of sensor coils can be used to determine both speed of sound in the fluid and the fluid bulk velocity.

The optical flowmeter may be a single continuous length of fiber (that can include the first and second optical fibers) or can include multiple fiber lengths that can be joined together, for example, through fusion splices or optical connectors.

In some examples, a first optical fiber can have sensor coils each with a fiber length that is shorter than a fiber length of each sensor coil of a second optical fiber of sensor coils. A sensitivity of interferometric measurement of the sensor coils can increase with the length of fiber in the sensor coil hence, the first fiber of sensor coils can be less sensitive than the second fiber of sensor coils.

In sensing applications, the coil length affects an interaction length between a light in the fiber and an external environment, which can influence a responsiveness of an optical sensor. When acoustic waves (sound waves) travel through a fluid in the tube or pipe (e.g., turbulent fluid), the acoustic waves cause the tubing to flex, which can include stress and/or strain. Although these vibrations are relatively small, the vibrations are still present due to physical properties of tubing material and energy carried by sound waves. Because optical coils are highly sensitive to stress and strain, when these fibers are wrapped around the tubing, the optical coils become sensitive to the vibrations and deformations of tubing walls caused by the acoustic waves. Thus, when the tubing vibrates due to the acoustic waves, the acoustic waves change physical properties of the tubing (e.g., stress and/or strain the tubing) and these vibrations stretch or compress the optical fibers wrapped around it. Thus, the acoustic waves within the tubing can cause the optical fiber(s) wrapped around the tubing to stretch or compress. The stretching or compressing of the optical fiber can alter a refractive index or a path length that light travels within the fiber, leading to changes in phase of the light.

For example, to determine the speed of sound in the tubing and the bulk velocity of the fluid in the tubing, an instrument (or device) (referred to as measurement device) can be used to inject or introduce the light into the optical flowmeter, which can be referred to as an optical wave (or waves). As the optical wave travels down a fiber, any disturbances it encounters can cause phase changes. For example, these disturbances can be caused or result from the strain of the tubing around and/or along which the fiber(s) are wrapped from the sound waves. The sound waves cause the tubing to flex and this causes the optical fiber to flex (or strain), which changes a length of the optical fiber.

In some examples, an optical interrogation process can be implemented to measure a differential optical phase change of a reflected optical signal across a gauge length of fiber at each sample point along the fiber. The gauge length of the interferometric differential phase measurements is the length of fiber between the two sample points that comprise the optical interference measurement. In a DAS instrument this is a length that can be set in an instrument configuration. For a Bragg grating based interferometer (e.g., Weatherford RheosX), it is the length of fiber between the fiber Bragg gratings placed between every sensing coil (e.g., the coil length). Each optical measurement can provide the differential phase between a beginning point of the gauge length and an end point of the gauge length for every sampling point (e.g., spatial location) along the fiber. The optical measurements can be updated at frequencies that are greater than one (1) kilohertz (KHz) in some instances. A rate of (differential) phase change can be determined by subtracting a state of differential phase for a current measurement from a state of differential phase from a previous measurement at the same sampling point (e.g., spatial location).

Interferometric optical phase measurements produce results in the range +/−π, and any values greater than this can be wrapped into the +/−π range. For example, a differential phase change between subsequent measurements of −0.5π, +1.5π and +3.5π can produce a same measurement result (−0.5π). Thus, if an actual physical rate of differential phase change is greater than +/−π between subsequent measurements then the result is ambiguous and can result in an error in an acoustic wave reconstruction. A phase unwrapping algorithm can be applied to improve acoustic signal reconstruction, but such algorithms have limitations, which impacts an accuracy of acoustic signal reconstructions. This results in a limited differential phase-rate dynamic range for quality measurements. Errors in a reconstructed acoustic signal can result in inaccurate determination of the speed of sound in the fluid and bulk velocity of the fluid or even failure of a processing algorithm to derive any value. A DAS instrument can be able to reduce a gauge length of its measurement to avoid such errors, which reduces the measurement sensitivity.

A sensing system is disclosed herein according to one or more examples. The sensing system includes an instrument (measurement device) and a flowmeter with a first optical fiber and a second optical fiber. The sets of coils can be wrapped around a tubing section through which a fluid can flow. The first and second optical fibers can include sets of coils, such as a first and second set of coils. In some examples, the first and second set of coils of the first and second optical fibers can have a respective similar (or same) coil length. For example, the first and second set of coils of the first optical fiber can have a first coil length (e.g., 20 meters), and the first and second set of coils of the second optical fiber can have a second coil length (e.g., 100 meters). The first coil length can be less than the second coil length. Because the first and second set of coils of the first optical fiber have a smaller coil length than the first and second set of coils of the second optical fiber, the first and second set of coils of the first optical fiber can be referred to as low sensitivity coils and the first and second set of coils of the second optical fiber can be referred to as high sensitivity coils.

In each of the first and second optical fibers, the first set of coils can be spaced apart according to a first spacing and can be used to produce optical signals (optical waves) indicative of a speed of sound in the fluid (e.g., production fluid). The second set of coils can be spaced apart according to a second spacing and can be used to produce optical signals indicative of the bulk velocity of the fluid. The first and second spacing can differ. In some examples, the first spacing is greater than the second spacing such that the first set of coils are spaced farther apart from each other than the second set of coils. The first set of coils can be widely spaced, and the first set of coils can be used to measure the speed of sound in the fluid because of a high velocity (e.g., about 1400 m/s) of those acoustic waves. The second set of coils are a closer spaced group of coils and can be used to measure the bulk velocity of the fluid because of the lower velocity (e.g., about 10 m/s) at which the fluid flows than sound waves. In this way, each fiber will produce a measurement of both speed of sound in the fluid and the fluid bulk velocity. In some cases, one set of coils may produce a measurement of both speed of sound in the fluid and the fluid bulk velocity.

According to the examples herein, one of the first and second optical fibers can be selected. In some examples, a decision as to whether the first and second optical coils of the first optical fiber or the second optical fiber are used can be based on assessment of a maximum rate of phase change with respect to the sensor coils relative to an interrogation update period, which may be based on knowledge of the well conditions or on the actual measured phase-rate data. In some examples, the preference can be to use the longer, more sensitive coils. In some examples, a quality factor can be calculated, which can be used to determine which optical coils are used. In some examples, the decision can utilize data from one or more of: differential phase data, reconstructed phase data, unwrapping algorithm, well conditions, well equipment control settings, and other well sensors. In some examples, data from both coils can be used to calculate separate values and the decision on which to use can be based on a quality factor of the calculation process.

The sensing system can use the first optical fiber as this optical fiber is less sensitive than the second optical fiber, which avoids phase over-ranging. The coils of the second optical fiber, being more sensitive, will have a larger phase change for a same acoustic signal compared to coils of the first optical fiber. The coils of the first optical fiber, due to their reduced length and thus lower sensitivity, will have a smaller phase response for the same acoustic signal compared to the coils of the second optical fiber. This characteristic of the coils of the first optical fiber having a smaller coil length ratio (e.g., Lₛₕₒᵣₜ/L_{long} ratio) and thus a smaller phase response) makes them more suitable for measuring much larger acoustic signals, such as in noisy systems, without encountering a phase over-ranging problem. By using the coils of the first optical fiber for larger acoustic signals, the system reduces the likelihood of this over-ranging. The lower sensitivity of the coils of the first optical fiber (reflected in the smaller phase response) means that larger phase changes can occur without exceeding the measurement capabilities of the system. Because the sensing system switches between using (data) low and high sensitivity coils allows for flexible and accurate measurements across a wide range of signal environments or wells and does not require prior knowledge of a final well layout or predicting well equipment acoustic profiles.

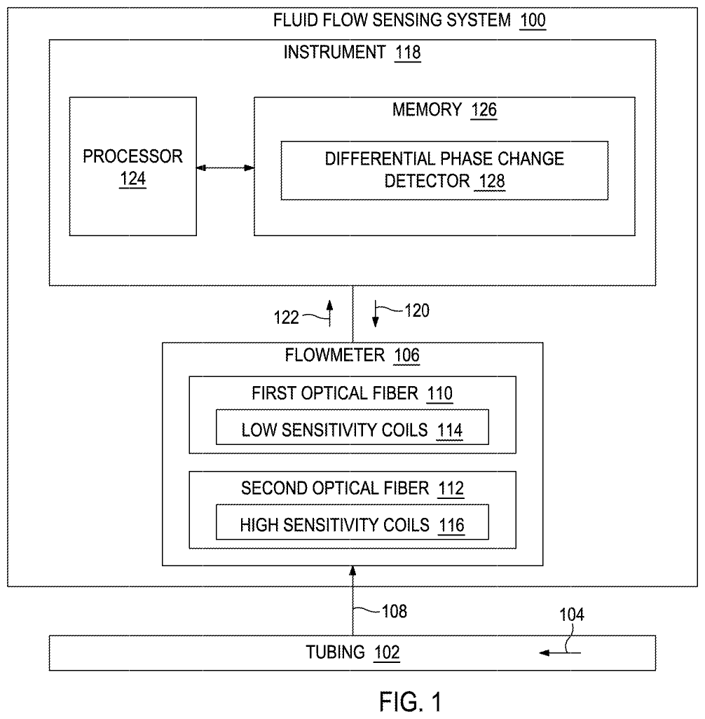

FIG. 1 is a schematic diagram of an example of a sensing system 100 for non-invasively (or non-intrusively) measuring fluid flow parameters, such as a speed of sound through a fluid 104 or bulk velocity of the fluid within tubing 102 of a well. The tubing 102 can be representative of a production pipe (or casing). A well is a hole that is drilled into the Earth's surface, or potentially a moon (e.g., Saturn's moon, Titan), and can be used to access and extract oil, natural gas, and/or other subsurface resources (referred to herein as hydrocarbons). The type of well depends on a type of hydrocarbon being extracted. Once the well is drilled and reaches (penetrates) a reservoir (sometimes called a petroleum reservoir), the production pipe can be introduced to extract the hydrocarbons from the reservoir. The production pipe, sometimes referred to as production tubing or simply tubing, is a conduit that runs from the well surface down a wellbore, and facilitates the extraction of hydrocarbons and transportation of fluids (e.g., oil, gas, and/or water) from a reservoir to the well surface. Production pipes are generally made of steel and are designed to withstand harsh conditions and high pressure encountered in oil and gas reservoirs. Inside the production pipe, various tools and equipment can be located, such as pumps and valves, which may be used to control the flow of fluids.

During operation, the fluid 104 flows through the tubing 102 to the surface. In some examples, the fluid 104 may be a multiphase fluid. The fluid 104 can be composed of multiple components, for example, hydrocarbons (e.g., crude oil, natural gas, etc.), water, other fluids (e.g., hydrogen sulfide or carbon dioxide), and/or solid and sediments. In some examples, the fluid 104 can contain one or more additives. Sound waves can travel in the tubing 102. In some examples, the sound waves are injected or introduced into the tubing 102 so that the speed of sound in the fluid 104 can be measured. In some instances, the bulk velocity of the fluid 104 can be measured as well. The fluid 104 flowing through the tubing 102 can cause the tubing 102 to flex. The sound waves can cause the tubing 102 to flex as well because of a pressure (or pressure variations) caused by the sound waves on the tubing 102. For example, the acoustic waves and the fluid 104 can cause a pipe wall of tubing 102 to experience stress and strain and thus flex. Flex or flexing as used herein refers to a bending or deformation of a tube. The flexing can be caused by the pressure variations from the sound waves or pressure changes from the fluid flow of the fluid 104.

As illustrated, the sensing system 100 includes a flowmeter 106 to detect the speed of sound and bulk velocity in the tubing 102, which is shown in the example of FIG. 1 with an arrow and identified with reference numeral 108. The flowmeter 106 can include a (custom) tubing section, which can be referred to as a flowmeter tubing. In some examples, the flowmeter can be machined from a single block of steel with all of the bosses, threads and bores as a monolithic piece. “Bosses” refer to protruding features designed to serve as mounting points or to reinforce areas where other components might be attached. “Threads” are the spiral ridges used for screwing parts together, and “bores” are holes or tunnels within the piece. A sleeve could be welded on as well. The flowmeter tubing can be incorporated into the tubing 102 to integrate the flowmeter 106 into the tubing 102. The flowmeter 106 includes a first optical fiber 110 and a second optical fiber 112.

The first optical fiber 110 can include low sensitivity coils 114 and the second optical fiber 112 can include high sensitivity coils 116. The low and high sensitivity coils 114 and 116 refer to sets of coils (e.g., two or more coil sets). The sets of coils can be wrapped around the flowmeter tubing. The first and second optical fibers 110 and 112 include the sets of coils, such as first and second set of coils. A length of fiber in a sensor coil can be in a range of 10 meters (m) to 100 m in some instances. Thus, the flowmeter 106 can include two sets of sensor coils with each set containing a group of sensor coils at a spacing along the flowmeter tubing suitable for producing signals to determine the speed of sound in the fluid and a group of sensor coils at a spacing suitable for producing signals to determine the bulk velocity of the fluid. In some examples, the two groups of sensor coils in a given set can share one or more sensor coils. In some examples, a same group of sensor coils can be used to determine both speed of sound in the fluid and the fluid bulk velocity. In some examples, a first set of sensor coils can have sensor coils each with a fiber length that is shorter than a fiber length of each sensor coil of a second set of sensor coils. A sensitivity of interferometric measurement of the sensor coils can increase with the length of fiber in the sensor coil hence, the first set of sensor coils can be less sensitive than the second set of sensor coils.

In some examples, the first and second set of coils of the first optical fiber 110 can have a first coil length (e.g., 20 meters). The first and second set of coils of the second optical fiber 112 can have a second coil length (e.g., 100 meters). The first and second set of coils of the first optical fiber 110 can be referred to as the low sensitivity coils 114 and the first and second set of coils of the second optical fiber 112 can be referred to as high sensitivity coils 116. While the example of FIG. 1 illustrates two optical fibers in other examples, a single optical fiber can be used and arranged with the low and high sensitivity coils 114-116, as disclosed herein. In some examples, the first and second optical fibers 110 and 112 can be coupled (e.g., using an optical coupling device, for example, optical reflector device, as described in the '150 Patent) to define or form the flowmeter 106, as shown in FIG. 1. In some examples, a spacer coil is located between the low sensitivity coils 114 and the high sensitivity coils 116.

The first set of coils can be spaced apart according to a first spacing and can be used to produce optical signals (optical waves) indicative of the speed of sound in the fluid 104. The second set of coils can be spaced apart according to a second spacing and can be used to produce optical signals indicative of the bulk velocity of the fluid 104. The first and second spacing can differ. In some examples, the first spacing is greater than the second spacing such that the first set of coils are spaced farther apart from each other than the second set of coils. Each set of coils will produce a measurement of both speed of sound in the fluid 104 and the fluid bulk velocity. Thus, each of the low sensitivity coils 114 and the high sensitivity coils 116 can be used to measure the speed of sound in the fluid 104 and the bulk velocity of the fluid 104.

A sensitivity of each of the first and second coil sets in each of the first and second optical fibers is based on a respective coil length for that set. The coil length of an optical coil can determine a sensitivity of the coil. A longer coil length can increase a sensitivity of the optical coil. Because the second optical fiber 112 has optical coils with a greater coil length than optical coils of the first optical fiber 110, the second optical fiber 112 is more sensitive than the first optical fiber 110. Thus, a sensitivity of interferometric measurement of the sensor coils can increase with the length of fiber in the sensor coil hence, the first set of sensor coils can be less sensitive than the second set of sensor coils. According to the examples herein, one of the first and second optical fibers 110 and 112 can be selected and used to allow for both maximum sensitivity for quiet systems (e.g., by using data from the first and second optical coils from the second optical fiber) and tolerance of large acoustic signals in noisy systems (e.g., by using data from the first and second optical coils from the first optical fiber).

In some examples, the first optical fiber 110 and thus the low sensitivity coils 114 are wrapped or placed first on the flowmeter tubing section followed by the second optical fiber 112 and its high sensitivity coils 116. An end of the first optical fiber 110 can be coupled to an end of the second optical fiber 112, and a remaining end of the first optical fiber 110 can be coupled to an instrument 118 of the sensing system 100. In this configuration, light or one or more optical waves 120 (referred to as optical waves herein) injected or provided to the flowmeter 106 is propagated through the low sensitivity coils 114 (first) before propagating through the high sensitivity coils 116. In other examples, the low sensitivity coils 114 and the high sensitivity coils 116 are interleaved physically on the flowmeter tubing section to minimize or reduce an overall length of the flowmeter 106 (e.g., the flowmeter tubing section). In some examples, between each of the coils of the low sensitivity coils 114 and/or the high sensitivity coils 116 an optical reflector device can be positioned, for example, as described in the '150 Patent. In some examples, the optical reflector device is a Bragg grating. In other examples, the optical reflector device can be distributed along an entire length of the optical fiber to increase a reflected signal level. Optical reflector devices can be used with <1% reflectivity in order to not significantly reduce a pulse power level of the optical waves 120 generated by the instrument 118.

In some examples, the instrument 118 is an interferometric-based instrument, such as a Weatherford Rheos/RheosX, or an optical distributed acoustic sensing (DAS) instrument. Other types of instruments and/or devices are contemplated within the scope of the present disclosure. As shown in the example of FIG. 1, the instrument 118 can generate or provide the optical waves 120, which can be used for detecting the speed of sound in the fluid 104 and/or the bulk velocity of the fluid 104. For clarity and brevity purposes, a light generating source (e.g., a laser) of the instrument 118 is not shown in the example of FIG. 1. The optical waves 120 can be propagated through the low sensitivity coils 114 and the high sensitivity coils 116 and reflected back (e.g., through a portion of a coil, or an optical reflector device) as one or more reflected optical waves 122 (referred to here as reflected optical waves), which can be received by the instrument 118. At a point at which the light is reflected back is a sampling point. When the tubing 102 flexes (e.g., from the soundwave or the fluid flow), the first and second optical fibers 110 and 112 wrapped around the tubing 102 also stretch, which impacts characteristics of the optical waves 120. For example, this can affect characteristics of the low sensitivity coils 114 and the high sensitivity coils 116, which cause changes to the optical waves 120, which can be detected by the instrument 118.

In some examples, an optical interrogation process can be implemented to measure a differential optical phase change of the reflected optical waves 122 across a gauge length of fiber at each sample point along the fiber. The gauge length of the interferometric differential phase measurements is the length of fiber between the two sample points that can include the optical interference measurement. For the instrument 118 this can be a length that can be set in a configuration of the instrument 118. For a Bragg grating based interferometer (e.g., Weatherford RheosX), it can be the length of fiber between the fiber Bragg gratings placed between every sensing coil (e.g., the coil length). Each optical measurement can provide the differential phase between a beginning point of the gauge length and an end point of the gauge length for every sampling point (e.g., spatial location) along the fiber. The optical measurements can be updated at frequencies that are greater than one (1) KHz in some instances. A rate of (differential) phase change can be determined by the instrument 118 by subtracting a state of differential phase for a current measurement from a state of differential phase from a previous measurement at the same sampling point (e.g., spatial location).

The instrument 118 can be configured to use one of the low sensitivity coils 114 and the high sensitivity coils 116 to avoid the over-ranging problem, as described herein. For example, the instrument 118 can use data from the high sensitivity coils 116 when greater sensitivity is needed to measure or detect the speed of sound in the fluid 104 or the bulk velocity of the fluid 104. Thus, the high sensitivity coils 116 can be used when an acoustic signal is small (e.g., in a quiet system) due the high sensitivity coils 116 have a greater sensitivity. The instrument 118 can switch to the low sensitivity coils 114 and thus use data from the low sensitivity coils 114 to measure or detect the speed of sound in the fluid 104 or the bulk velocity of the fluid 104 when the acoustic signal is large (e.g., in a noisy system). A quiet system can have a low turbulence flow or no in-well equipment that produces additional noise. A noisy system may have active equipment that produces noise (e.g., Electrical Submersible Pumps (ESP)) or passive noise sources such as valve apertures, tubing leaks, casing leaks, packer leaks, or vibrations in high-rate wells, etc.

The instrument 118 can switch to using the data from the low sensitivity coils 114 when the reflected optical signal 122 from the high sensitivity coils 116 exceeds a maximum phase dynamic range of the instrument 118. The low sensitivity coils 114 can produce a differential phase response Lₛₕₒᵣₜ/L_{long} smaller than the high sensitivity coils 116, which will allow measurement of much larger acoustic signals. Because in some examples, the low sensitivity coils 114 are located before any of the high sensitivity coils 116 on the tubing 102 relative to the instrument 118, a phase signal on those coils will be unaffected by any signal over-ranging that occurs in the high sensitivity coils 116 following the low sensitivity coils 114. For example, the instrument 118 can include a processor 124 and memory 126, which can include a differential phase change detector 128. The processor 124 can access the memory 126 to execute machine-readable instructions for implementing one or more aspects of the present disclosure.

For example, the instrument 118 can be configured to initially use data from the high sensitivity coils 116 of the second optical fiber 112. The instrument 118 processes the reflected optical waves 122 (the data) from the high sensitivity coils 116 to determine a rate of a differential phase change in response to providing the optical waves 120. If the rate of differential phase change approaches +/−π for a given number of samples (e.g., which can be user defined) when using the data from the high sensitivity coils 116 then the data from the low sensitivity coils 114 can be used instead. Thus, the instrument 118 can determine how fast or quickly a phase of the reflected optical waves 122 is changing over time. The +/−π can define a threshold, which is a maximum dynamic range of the instrument 118. The maximum dynamic range of the instrument 118 specifies an upper limit or a maximum extent of phase shift variation that the instrument 118 can handle without loss of accuracy or functionality. If the phase shift of a signal goes beyond this range, the instrument 118 may no longer be able to provide reliable readings. For example, if the rate of the differential phase change is greater than or equal to the threshold, this can be an indication to switch to using the data from the low sensitivity coils 114 when the reflected optical signal 122. Thus, the instrument 118 can switch to using the data from the low sensitivity coils 114 when the reflected optical signal 122 from the high sensitivity coils 116 exceeds a maximum phase dynamic range of the instrument 118.

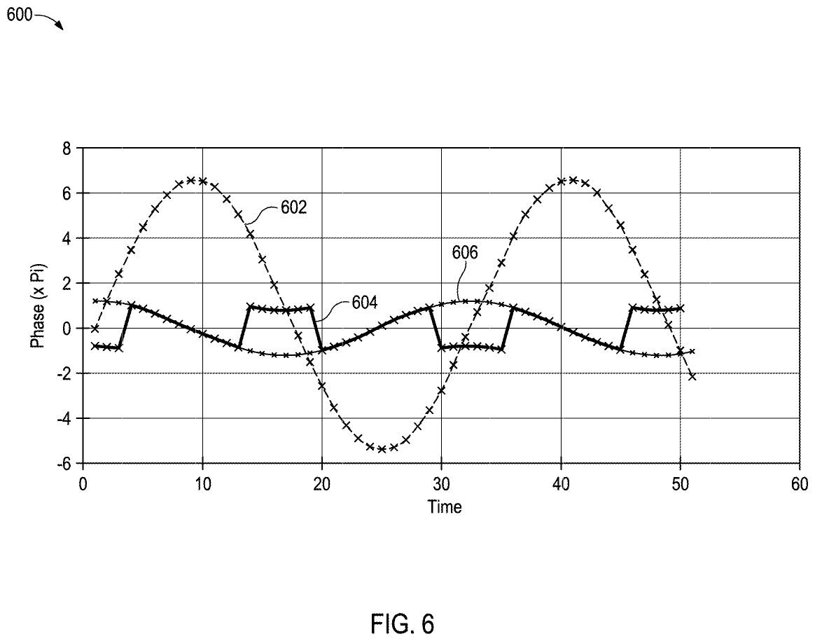

The instrument 118 can be configured to implement a measurement or calculation process based on the differential phase change across a gauge length at each sampling point along an optical fiber. The gauge length of interferometric differential phase measurements is a length of fiber between the two sample points that can include an optical interference measurement. In a DAS instrument, this is a length that can be set in the instrument configuration, for the RheosX instrument (Bragg grating based interferometer) it is the length of fiber between the fiber Bragg gratings placed between every sensing coil (e.g., the coil length). Each optical measurement (e.g., the reflected optical waves 122) received by the instrument 118 can provide a differential phase between a beginning point of a gauge length and an end point of the gauge length for every sampling point (spatial location) along the optical fiber. The optical measurements can be updated by the instrument 118 at frequencies greater than 1 KHz. The differential phase change detector 128 can determine the rate of (differential) phase change by subtracting a state of differential phase for a current measurement from a state of differential phase from a previous measurement at a same sampling point (spatial location). The differential phase change measurement can be cyclic over a range of 2π. FIG. 6 is an example of a phase wrapping diagram 600. An x-axis of the diagram 600 represents time, and a y-axis of the diagram 600 represents a phase. The phase wrapping diagram 600 includes an acoustic signal 602, an actual phase change signal 604 and a measured phase change signal 606. The acoustic signal 602 is the phase change between two fiber sample points due to a sound wave that is introduced into the tubing 102 and thus the flowmeter tubing section. The actual phase signal 604 represents the differential phase change of the acoustic signal over time. The measured phase change signal 606 represents the differential phase change of the acoustic signal over time that is measured by the flowmeter instrument 118. Thus, if the phase (or phase difference) of the optical wave 602 is increased by 2π the measurement will be a similar value. Thus, if an actual differential phase change is greater than +/−π then the measurement result can be ambiguous and can result in an error in the acoustic wave reconstruction.

Thus, the differential phase change detector 128 can monitor the rate of the differential phase change and switch from using data from the high sensitivity coils 116 to using data from the low sensitivity coils 114 for determining the speed of sound in the fluid 104 or the bulk velocity of the fluid 104. The instrument 118 can receive the reflected optical waves 122 (data) that are indicative of the speed of sound in the fluid 104 flowing within the tubing 102. The instrument 118 in some instances can receive the reflected optical waves 122 (data) that can be indicative of pressure variations in the fluid 104 that can travel at approximately a same velocity as the fluid 104.

In some examples, a decision as to whether the first and second optical coils of the first optical fiber or the second optical fiber are used by the instrument 118 can be based on assessment of a maximum rate of phase change with respect to the sensor coils relative to an interrogation update period, which may be based on knowledge of the well conditions or on the actual measured phase-rate data. In some examples, the preference can be to use the longer, more sensitive coils. In some examples, a quality factor can be calculated by the instrument 118, which can be used to determine which optical coils are used. In some examples, the decision as to which optical coils by the instrument 118 can be based on data from one or more of: differential phase data, reconstructed phase data, unwrapping algorithm, well conditions, well equipment control settings, other well sensors. In some examples, data from both coils can be used to calculate separate values and the decision on which to use can be based on a quality factor of the calculation process.

Accordingly, the sensing system 100 can use the high sensitivity coils 116 of the second optical fiber 112 as this optical fiber is more sensitive than the low sensitivity coils 114 of the first optical fiber 110. The coils of the second optical fiber 112, being more sensitive, will have a larger phase change for a same acoustic signal compared to the coils of the first optical fiber 110. The low sensitivity coils 114, due to their lower sensitivity, will have a smaller phase response for the same acoustic signal compared to the high sensitivity coils 116. This characteristic of the low sensitivity coils 114 having a smaller coil length and thus a smaller phase response makes them more suitable for measuring much larger acoustic signals, such as in noisy systems, without encountering the phase over-ranging problem. By using the low sensitivity coils 114 for larger acoustic signals, the sensing system 100 reduces the likelihood of this over-ranging. The lower sensitivity of the low sensitivity coils 114 (reflected in the smaller phase response) means that larger phase changes can occur without exceeding the measurement capabilities of the sensing system 100. Because the sensing system 100 switches between using low and high sensitivity coils 114 and 116 allows for flexible and accurate measurements across a wide range of signal environments or wells and does not require prior knowledge of a final well layout, or predicting well equipment acoustic profiles.

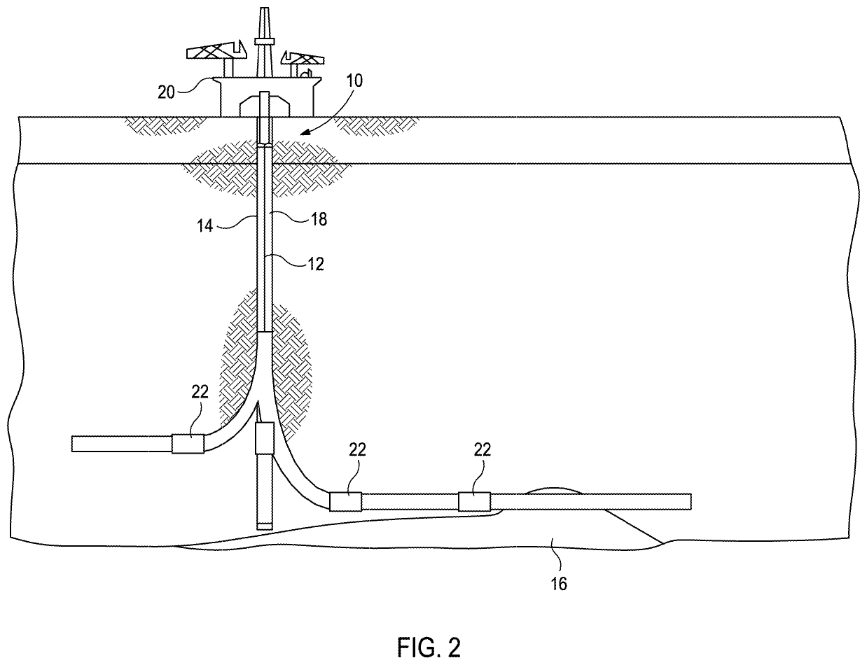

FIG. 2 is a schematic diagram of an example well system 10 that may incorporate the principles of the present disclosure. As illustrated, a wellbore 18 extends from a platform 20 arranged at the Earth's surface, and the wellbore 18 may be lined with casing 14. One or more production pipes 12 may extend from the platform 20 into the wellbore 18 within the casing 14 to fluidly communicate with one or more petroleum sources. An annulus is formed between the outer surface of the production pipe 12 and the inner wall of the casing 14.

As illustrated, the wellbore 18 can include one or more lateral sections that branch off to access different petroleum sources 16 or different areas of a same petroleum source 16. Fluid mixtures can be pumped from the petroleum source 16 to the platform 20 through the production pipes 12. The fluid mixtures consist predominantly of petroleum products and water. One or more of the production pipes 12 can include one or more flowmeters 22 for non-intrusively sensing fluid flow within a pipe to monitor various physical parameters of the fluid mixtures as they flow through the production pipes 12, as described herein. In some examples, the one or more flowmeters 22 correspond to the flowmeter 106 of FIG. 1. Thus, reference can be made to one or more examples of FIG. 1 in the example of FIG. 2.

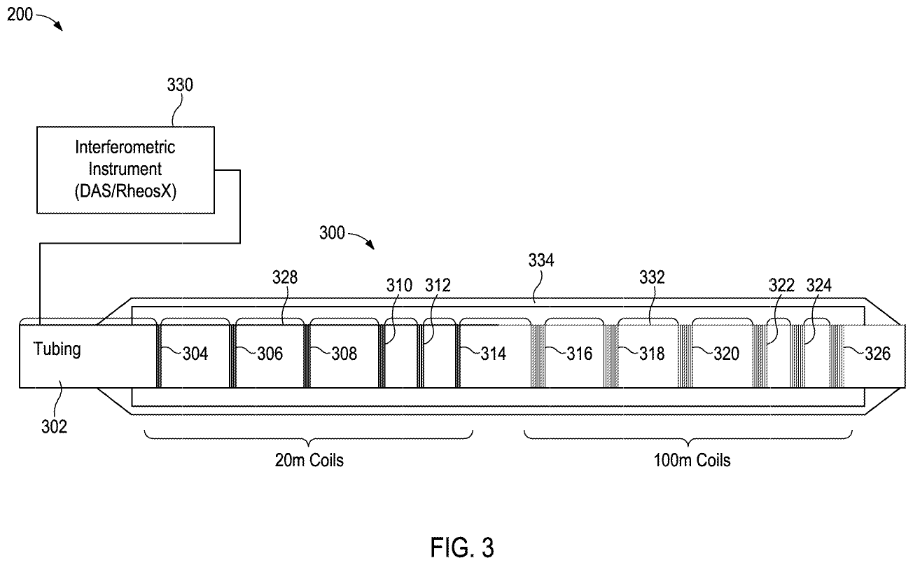

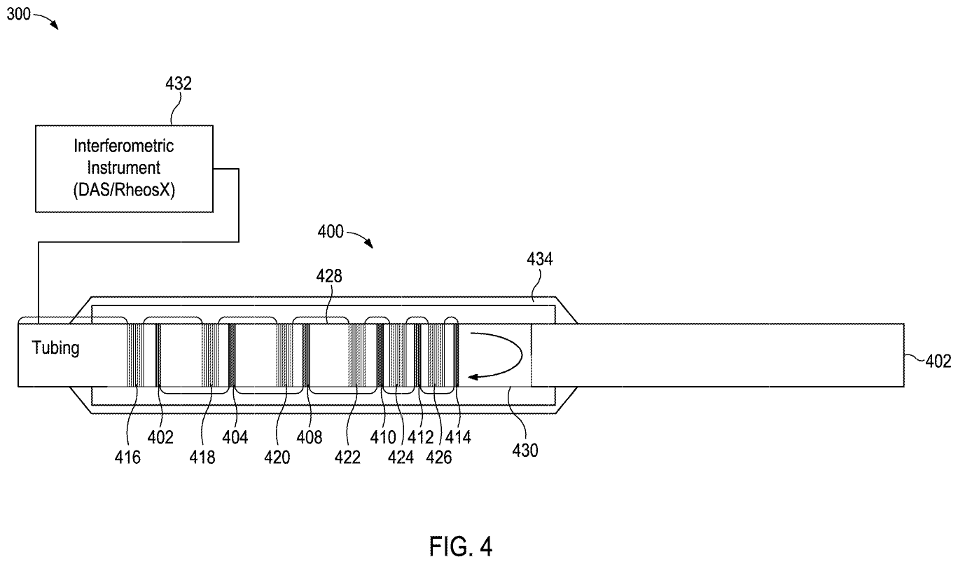

FIG. 3 is an example of a flowmeter 300 with a flowmeter tubing section 302. The flowmeter 300 can correspond to the flowmeter 106, as shown in FIG. 1. Thus, reference can be made to one or more examples of FIGS. 1-2 in the example of FIG. 3. As illustrated, the flowmeter 300 can include a first optical fiber 328 and a second optical fiber 332. The first optical fiber 328 includes coils 304-308 and coils 310-314, which can correspond to first and second set of coils. The flowmeter 300 can be coupled or connected to an instrument 330. The instrument 330 can correspond to the instrument 118, as shown in FIG. 1. In some examples, the instrument 330 and the flowmeter 300 define a sensing system, such as the sensing system 100, as shown in FIG. 1. Each of the coils 304-308 and coils 310-314 can have a similar coil length. In the example of FIG. 3, the coils 304-308 and coils 310-314 can have a coil length of 20 meters. The second optical fiber 332 includes coils 316-320 and coils 322-326, which can correspond to first and second set of coils. Each of the coils 316-320 and coils 322-326 can have a similar coil length. In the example of FIG. 3, the coils 316-320 and coils 322-326 can have a coil length of 100 meters. Because the coils 304-308 and coils 310-314 have a smaller coil length than the coils 316-320 and coils 322-326, the coils 304-308 and coils 310-314 can be referred to as low sensitivity coils and the coils 316-320 and coils 322-326 can be referred to as high sensitivity coils. In some examples, to avoid interference from outside sources and protect the high and low sensitivity coils from an external environment, in some instances, a harsh environment within the well, the high and low sensitivity coils can be located or enclosed within a housing 334, which in some instances can be implemented in a same or similar manner as the housing 28 of the '150 Patent. In the example of FIG. 3, the low and high sensitivity coils are connected in series. In other examples, the low and high sensitive coils can be interleaved, as shown in FIG. 4.

FIG. 4 is an example of a flowmeter 400 with a flowmeter tubing section 402. The flowmeter 400 can correspond to the flowmeter 106, as shown in FIG. 1. Thus, reference can be made to one or more examples of FIGS. 1-3 in the example of FIG. 4. In some examples, the flowmeter tubing section 402 is the flowmeter tubing section 302, as shown in FIG. 3. The flowmeter 400 can include low sensitivity coils 404-414 and high sensitivity coils 416-426. For example, a first optical fiber 428 can be configured into a series of loops such as the low sensitivity coils 404-414 and a second optical fiber 430 can be configured into a series of loops such as the high sensitivity coils 416-426. A first end of the first optical fiber 428 can be coupled to an interferometric instrument 432, as shown in FIG. 4. In some examples, the instrument 432 is implemented as the instrument 118, as shown in FIG. 1. In some examples, the instrument 432 and the flowmeter 400 define a sensing system, such as the sensing system 100, as shown in FIG. 1. A second end of the first optical fiber 428 can be coupled to a first end of the second optical fiber 430. A second end of the second optical fiber 430 can be terminated, or in other examples, connected back to the instrument 432 to define a closed loop optical system. As an example, the low sensitivity coils 404-414 can have coils with a coil length of 20 meters and the high sensitivity coils 416-426 can have coils with a coil length of 100 meters.

To avoid interference from outside sources and protect the low sensitivity coils 404-414 and the high sensitivity coils 416-426 from an external environment, in some instances, a harsh environment within the well, the low sensitivity coils 404-414 and the high sensitivity coils 416-426 can be located or enclosed within a housing 434, which in some instances can be implemented in a same or similar manner as the housing 28 of the '150 Patent. In the example of FIG. 4, the low sensitivity coils 404-414 and the high sensitivity coils 416-426 are physically interleaved and thus in contrast to the example of FIG. 3 thus the flowmeter 400 can be provided with a smaller flowmeter tubing section.

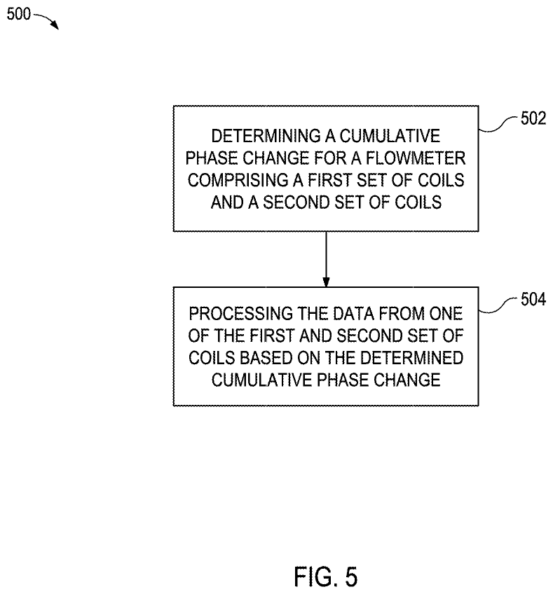

In view of the foregoing structural and functional features described above, example methods will be better appreciated with reference to FIG. 5. While, for purposes of simplicity of explanation, the example method of FIG. 5 is shown and described as executing serially, it is to be understood and appreciated that the present examples are not limited by the illustrated order, as some actions could in other examples occur in different orders, multiple times and/or concurrently from that shown and described herein. Moreover, it is not necessary that all described actions be performed to implement the methods.

FIG. 5 is an example of a method 500 for computing one of a speed of sound in a fluid in a tubing or a velocity of the fluid in the tubing. The method 500 can be implemented by the instrument 118, as shown in FIG. 1. Thus, reference can be made to one or more examples of FIGS. 1-4 in the example of FIG. 5. The method 500 can begin at 502 by determining a differential phase change for a flowmeter, such as the flowmeter 106, as shown in FIG. 1. The flowmeter can include low and high sensitivity coils that can be used for sensing a speed of sound in a fluid (e.g., the fluid 104, as shown in FIG. 1) in a tubing (e.g., the tubing 102, as shown in FIG. 1) or a velocity (e.g., bulk velocity) of the fluid. At 504, processing data from one of the low and high sensitivity coils in response to determining the determined differential phase change.

While the disclosure has described several exemplary embodiments, it will be understood by those skilled in the art that various changes can be made, and equivalents can be substituted for elements thereof, without departing from the spirit and scope of the invention. In addition, many modifications will be appreciated by those skilled in the art to adapt a particular instrument, situation, or material to embodiments of the disclosure without departing from the essential scope thereof. Therefore, it is intended that the invention not be limited to the particular embodiments disclosed, or to the best mode contemplated for carrying out this invention, but that the invention will include all embodiments falling within the scope of the appended claims. Moreover, reference in the appended claims to an apparatus or system or a component of an apparatus or system being adapted to, arranged to, capable of, configured to, enabled to, operable to, or operative to perform a particular function encompasses that apparatus, system, or component, whether or not it or that particular function is activated, turned on, or unlocked, as long as that apparatus, system, or component is so adapted, arranged, capable, configured, enabled, operable, or operative.

In view of the foregoing structural and functional description, those skilled in the art will appreciate that portions of the embodiments may be embodied as a method, data processing system, or computer program product. Accordingly, these portions of the present embodiments may take the form of an entirely hardware embodiment, an entirely software embodiment, or an embodiment combining software and hardware

The present invention may be a system, a method, and/or a computer program product at any possible technical detail level of integration. The computer program product may include a computer readable storage medium (or media) having computer readable program instructions thereon for causing a processor to carry out aspects of the present invention. The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware based systems that perform the specified functions or acts or carry out combinations of special purpose hardware and computer instructions.

Certain embodiments have also been described herein with reference to block illustrations of methods, systems, and computer program products. It will be understood that blocks of the illustrations, and combinations of blocks in the illustrations, can be implemented by computer-executable instructions. These computer-executable instructions may be provided to one or more processor of a general purpose computer, special purpose computer, or other programmable data processing apparatus (or a combination of devices and circuits) to produce a machine, such that the instructions, which execute via the processor, implement the functions specified in the block or blocks.

These computer-executable instructions may also be stored in computer-readable memory that can direct a computer or other programmable data processing apparatus to function in a particular manner, such that the instructions stored in the computer-readable memory result in an article of manufacture including instructions which implement the function specified in the flowchart block or blocks. The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions specified in the flowchart block or blocks.

### Additional Example Embodiments

Embodiments disclosed herein include:

Embodiment A: A sensing system comprising: a flowmeter comprising: low sensitivity coils comprising optical coils for sensing one or more fluid flow parameters of a flowing fluid; high sensitivity coils comprising optical coils for sensing the one or more fluid flow parameters of the fluid; and wherein the low sensitivity coils are selected and so that an instrument receives data from the low sensitivity coils indicative of the one or more fluid flow parameters during a first period of time; and wherein the high sensitivity coils are selected so that the instrument receives data from the high sensitivity coils indicative of the one or more fluid flow parameters during a second period of time.

Embodiment B: A method comprising: determining a differential phase change for a flowmeter comprising low and high sensitivity coils used for sensing flow parameters of a fluid; and processing data from one of the low and high sensitivity coils in response to the determined differential phase change.

Embodiment C: An instrument comprising: a processor; memory comprising machine-readable instructions, the machine-readable instructions being executable by the processor and causing the processor to: receive data from low and high sensitivity coils; compare a rate of a differential phase change to a threshold corresponding to maximum dynamic range of the instrument; process the data from the high sensitivity coils over a first period of time based on the comparison indicating that the rate of the differential phase change is less than the threshold; and process the data from the low sensitivity coils over a second period of time based on the comparison indicating that the rate of the differential phase change is greater than or equal to the threshold.

Each of embodiments A through C may have one or more of the following additional elements in any combination: Element 1: wherein the low sensitivity coils comprise a first set of optical coils and a second set of optical coils and the high sensitivity coils comprise a third set of optical coils and a fourth set of optical coils; Element 2: wherein the first set of optical coils are spaced apart on a tubing section according to a first spacing and the second set of optical coils are spaced apart on the tubing section according to a second spacing; Element 3: wherein the third set of optical coils are spaced apart on the tubing section according to the first spacing and the fourth set of optical coils are spaced apart on the tubing section according to the second spacing; Element 4: wherein the first and third set of optical coils are used to sense a first fluid flow parameter of the flowing fluid and the second and fourth set of optical coils are used to sense a second fluid flow parameter of the fluid; Element 5: wherein the first fluid flow parameter is a speed of sound through the flowing fluid and the second fluid flow parameter is a velocity of the flowing fluid; Element 6: wherein the low sensitivity coils and the high sensitivity coils are interleaved on a tubing section; Element 7: further comprising the instrument, the instrument being configured to determine whether to select one of the low and high sensitivity coils based on one or more of an assessment of a maximum rate of phase change, a quality factor, differential phase data, reconstructed phase data, an unwrapping algorithm, well conditions, and well equipment control settings; Element 8: wherein the instrument is configured to receive data from the low sensitivity coils and process the data from the low sensitivity coils during the first period of time, and receive data from the high sensitivity coils and process the data from the high sensitivity coils during the second period of time based on the determination; Element 9: wherein the instrument comprises: a processor; and memory comprising machine-readable instructions, the machine-readable instructions being executable by the processor, the machine-readable instructions comprising a differential phase detector programmed to select one of the high and low sensitivity coils to receive the data indicative of the fluid flow parameters; Element 10: wherein the data is processed from the high sensitivity coils over a first period of time, and the data is processed from the low sensitivity coils over a second period of time; Element 11: further comprising providing a tubing section with the low and high sensitivity coils arranged on the tubing section, the low sensitivity coils comprising optical coils for sensing one or more fluid flow parameters of the fluid, and the high sensitivity coils comprising optical coils for sensing the one or more fluid flow parameters of the fluid, the fluid flowing through the tubing section; Element 12: wherein the low sensitivity coils comprise a first and second set of optical coils, and the high sensitivity coils comprise a third and fourth set of optical coils, the providing comprising: spacing apart on the tubing section the first and third set of optical coils according to a first spacing; and spacing apart on the tubing section the second and fourth set optical coils according to a second spacing; Element 13: further comprising receiving the data from the low and high sensitivity coils and selecting the data from one of the low and high sensitivity coils for processing; Element 14: further comprising interrogating the low and high sensitivity coils, wherein the data is received from the low and high sensitivity coil in response to the interrogation; Element 15: wherein the low sensitivity coils comprise optical coils for sensing one or more fluid flow parameters of a flowing fluid, and the high sensitivity coils comprise optical coils for sensing the one or more fluid flow parameters of the flowing fluid; Element 16: wherein the low sensitivity coils comprise a first set of optical coils and a second set of optical coils and the high sensitivity coils comprise a third set of optical coils and a fourth set of optical coils; and Element 17: wherein the first set of optical coils are spaced apart on a tubing section according to a first spacing and the second set of optical coils are spaced apart on the tubing section according to a second spacing, and wherein the third set of optical coils are spaced apart on the tubing second according to the first spacing and the fourth set of optical coils are spaced apart on the tubing section according to the second spacing.

The terminology used herein is for the purpose of describing particular embodiments only and is not intended to be limiting of the invention. As used herein, for example, the singular forms “a,” “an,” and “the” are intended to include the plural forms as well, unless the context clearly indicates otherwise. It will be further understood that the terms “contains”, “containing”, “includes”, “including,” “comprises”, and/or “comprising,” and variations thereof, when used in this specification, specify the presence of stated features, integers, steps, operations, elements, and/or components, but do not preclude the presence or addition of one or more other features, integers, steps, operations, elements, components, and/or groups thereof. In addition, the use of ordinal numbers (e.g., first, second, third, etc.) is for distinction and not counting. For example, the use of “third” does not imply there must be a corresponding “first” or “second.” Also, as used herein, the terms “coupled” or “coupled to” or “connected” or “connected to” or “attached” or “attached to” may indicate establishing either a direct or indirect connection, and is not limited to either unless expressly referenced as such. Furthermore, to the extent that the terms “includes,” “has,” “possesses,” and the like are used in the detailed description, claims, appendices and drawings such terms are intended to be inclusive in a manner similar to the term “comprising” as “comprising” is interpreted when employed as a transitional word in a claim. The term “based on” means “based at least in part on.” The terms “about” and “approximately” can be used to include any numerical value that can vary without changing the basic function of that value. When used with a range, “about” and “approximately” also disclose the range defined by the absolute values of the two endpoints, e.g., “about 2 to about 4” also discloses the range “from 2 to 4.” Generally, the terms “about” and “approximately” may refer to plus or minus 5-10% of the indicated number.

What has been described above include mere examples of systems, computer program products and computer-implemented methods. It is, of course, not possible to describe every conceivable combination of components, products and/or computer-implemented methods for purposes of describing this disclosure, but one of ordinary skill in the art can recognize that many further combinations and permutations of this disclosure are possible. The descriptions of the various embodiments have been presented for purposes of illustration, but are not intended to be exhaustive or limited to the embodiments disclosed. Many modifications and variations will be apparent to those of ordinary skill in the art without departing from the scope and spirit of the described embodiments.

The invention claimed is:

1. A sensing system comprising:
a flowmeter comprising:
low sensitivity coils comprising optical coils for sensing one or more fluid flow parameters of a flowing fluid;
high sensitivity coils comprising optical coils for sensing the one or more fluid flow parameters of the fluid; and
wherein the low sensitivity coils are selected and so that an instrument receives data from the low sensitivity coils indicative of the one or more fluid flow parameters during a first period of time; and
wherein the high sensitivity coils are selected so that the instrument receives data from the high sensitivity coils indicative of the one or more fluid flow parameters during a second period of time.

2. The sensing system of claim 1, wherein the low sensitivity coils comprise a first set of optical coils and a second set of optical coils and the high sensitivity coils comprise a third set of optical coils and a fourth set of optical coils.

3. The sensing system of claim 2, wherein the first set of optical coils are spaced apart on a tubing section according to a first spacing and the second set of optical coils are spaced apart on the tubing section according to a second spacing.

4. The sensing system of claim 3, wherein the third set of optical coils are spaced apart on the tubing section according to the first spacing and the fourth set of optical coils are spaced apart on the tubing section according to the second spacing.

5. The sensing system of claim 4, wherein the first and third set of optical coils are used to sense a first fluid flow parameter of the flowing fluid and the second and fourth set of optical coils are used to sense a second fluid flow parameter of the fluid.

6. The sensing system of claim 5, wherein the first fluid flow parameter is a speed of sound through the flowing fluid and the second fluid flow parameter is a velocity of the flowing fluid.

7. The sensing system of claim 1, wherein the low sensitivity coils and the high sensitivity coils are interleaved on a tubing section.

8. The sensing system of claim 1, further comprising the instrument, the instrument being configured to determine whether to select one of the low and high sensitivity coils based on one or more of an assessment of a maximum rate of phase change, a quality factor, differential phase data, reconstructed phase data, an unwrapping algorithm, well conditions, and well equipment control settings.

9. The sensing system of claim 8, wherein the instrument is configured to receive data from the low sensitivity coils and process the data from the low sensitivity coils during the first period of time, and receive data from the high sensitivity coils and process the data from the high sensitivity coils during the second period of time based on the determination.

10. The sensing system of claim 1, wherein the instrument comprises:
a processor; and
memory comprising machine-readable instructions, the machine-readable instructions being executable by the processor, the machine-readable instructions comprising a differential phase detector programmed to select one of the high and low sensitivity coils to receive the data indicative of the fluid flow parameters.

11. A method comprising
determining a differential phase change for a flowmeter comprising low and high sensitivity coils used for sensing flow parameters of a fluid; and
processing data from one of the low and high sensitivity coils in response to the determined differential phase change.

12. The method of claim 11, wherein the data is processed from the high sensitivity coils over a first period of time, and the data is processed from the low sensitivity coils over a second period of time.

13. The method of claim 12, further comprising providing a tubing section with the low and high sensitivity coils arranged on the tubing section, the low sensitivity coils comprising optical coils for sensing one or more fluid flow parameters of the fluid, and the high sensitivity coils comprising optical coils for sensing the one or more fluid flow parameters of the fluid, the fluid flowing through the tubing section.

14. The method of claim 13, wherein the low sensitivity coils comprise a first and second set of optical coils, and the high sensitivity coils comprise a third and fourth set of optical coils, the providing comprising:
spacing apart on the tubing section the first and third set of optical coils according to a first spacing; and
spacing apart on the tubing section the second and fourth set optical coils according to a second spacing.

15. The method of claim 12, further comprising receiving the data from the low and high sensitivity coils and selecting the data from one of the low and high sensitivity coils for processing.

16. The method of claim 15, further comprising interrogating the low and high sensitivity coils, wherein the data is received from the low and high sensitivity coil in response to the interrogation.

17. An instrument comprising
a processor;
memory comprising machine-readable instructions, the machine-readable instructions being executable by the processor and causing the processor to:
receive data from low and high sensitivity coils;
compare a rate of a differential phase change to a threshold corresponding to maximum dynamic range of the instrument;
process the data from the high sensitivity coils over a first period of time based on the comparison indicating that the rate of the differential phase change is less than the threshold; and
process the data from the low sensitivity coils over a second period of time based on the comparison indicating that the rate of the differential phase change is greater than or equal to the threshold.

18. The instrument of claim 17, wherein the low sensitivity coils comprise optical coils for sensing one or more fluid flow parameters of a flowing fluid, and the high sensitivity coils comprise optical coils for sensing the one or more fluid flow parameters of the flowing fluid.

19. The instrument of claim 17, wherein the low sensitivity coils comprise a first set of optical coils and a second set of optical coils and the high sensitivity coils comprise a third set of optical coils and a fourth set of optical coils.

20. The instrument of claim 17, wherein the first set of optical coils are spaced apart on a tubing section according to a first spacing and the second set of optical coils are spaced apart on the tubing section according to a second spacing, and
wherein the third set of optical coils are spaced apart on the tubing second according to the first spacing and the fourth set of optical coils are spaced apart on the tubing section according to the second spacing.
